(19) United States
(12) Patent Application Publication
(10) Pub. No.: US 2008/0165281 A1
(43) Pub. Date: Jul. 10, 2008

(54) Optimizing Execution of HD-DVD Timing Markup

(75) Inventors: Jeffrey Davis, Snohomish, WA (US); Joel Deaguero, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/770,167

(22) Filed: Jun. 28, 2007

Related U.S. Application Data
(60) Provisional application No. 60/883,751, filed on Jan. 5, 2007.

(51) Int. Cl. H04N 5/06

(52) U.S. Cl. 348/521; 348/E05.011

(57) ABSTRACT

Systems, methods, and/or techniques (“tools”) for optimizing execution of high-definition digital versatile disk (HD-DVD) timing markup are described herein. The tools may receive timing markup read from an HD-DVD disk, and optimize the processing of the timing markup using one or more of the optimization strategies described herein.

### REFERENCE TO PRIORITY APPLICATION

This application claims the benefit of U.S. Provisional Patent Application Ser. No. 60/883,751, filed on 5 Jan. 2007, entitled “Optimized Execution of HD-DVD Markup”, to the fullest extent permitted under 35 U.S.C. §119. This application also fully incorporates the contents of that provisional application by this reference, as if set forth verbatim herein.

### BACKGROUND

High-definition digital versatile disks (HD-DVD) media and related players are becoming more popular and widely used. As more manufacturers enter this market, competition increases, tending to drive prices downwards. In this pricing environment, software running within the HD-DVD players typically run on relatively inexpensive consumer hardware.

Transforming HD-DVD content and style markup into tangible form for display is computationally expensive. Typically, a reasonable goal for a rendering rate for HD-DVD markup is approximately 24 frames per second, for an acceptable user experience. Conventional techniques for transforming and rendering the HD-DVD markup may face difficulties when attempting to reach this rendering rate goal, by performing computationally expensive tasks on low-cost consumer hardware.

### SUMMARY

Systems, methods, and/or techniques (“tools”) for optimizing execution of high-definition digital versatile disk (HD-DVD) timing markup are described herein. The tools may receive timing markup read from an HD-DVD disk, and optimize the processing of the timing markup using one or more of the optimization strategies described herein.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTIONS OF THE DRAWINGS

Tools related to optimizing execution of HD-DVD timing markup are described in connection with the following drawing figures. The same numbers are used throughout the disclosure and figures to reference like components and features. The first digit in a reference number indicates the drawing figure in which that reference number is introduced.

FIG. 1 is a block diagram of operating environments for optimizing execution of HD-DVD timing markup.

FIG. 2 is a block diagram of additional aspects of a presentation engine and timing markup.

FIG. 3 is a block diagram of aspects of an XPATH expression manager and strategies for optimizing the processing of the timing markup.

FIG. 4 is a block diagram of data and process flows for processing the timing markup.

FIG. 5 is a block diagram of additional aspects of the data and process flows shown in FIG. 4.

FIG. 6 is a block diagram of components and process flows related to optimization strategies involving pre-parsing and pre-computing certain XPATH expressions.

FIG. 7 is a block diagram of components and flows related to optimizing event-driven expressions.

FIG. 8 is a block diagram of process flows for optimizing processing of event-dependent expressions.

FIG. 9 is a block diagram of optimization techniques using finite state machines.

FIG. 10 is a block diagram of components and flows related to optimizing the processing of timing markup using a shared memory pool.

FIG. 11 is a block diagram of optimization techniques related to using schedulers to reduce timing tree traversals.

### DETAILED DESCRIPTION

### Overview

The following document describes tools capable of performing and/or supporting many techniques and processes. The following discussion describes exemplary ways in which the tools may optimize execution of HD-DVD timing markup. This discussion also describes other techniques and/or processes that the tools may perform.

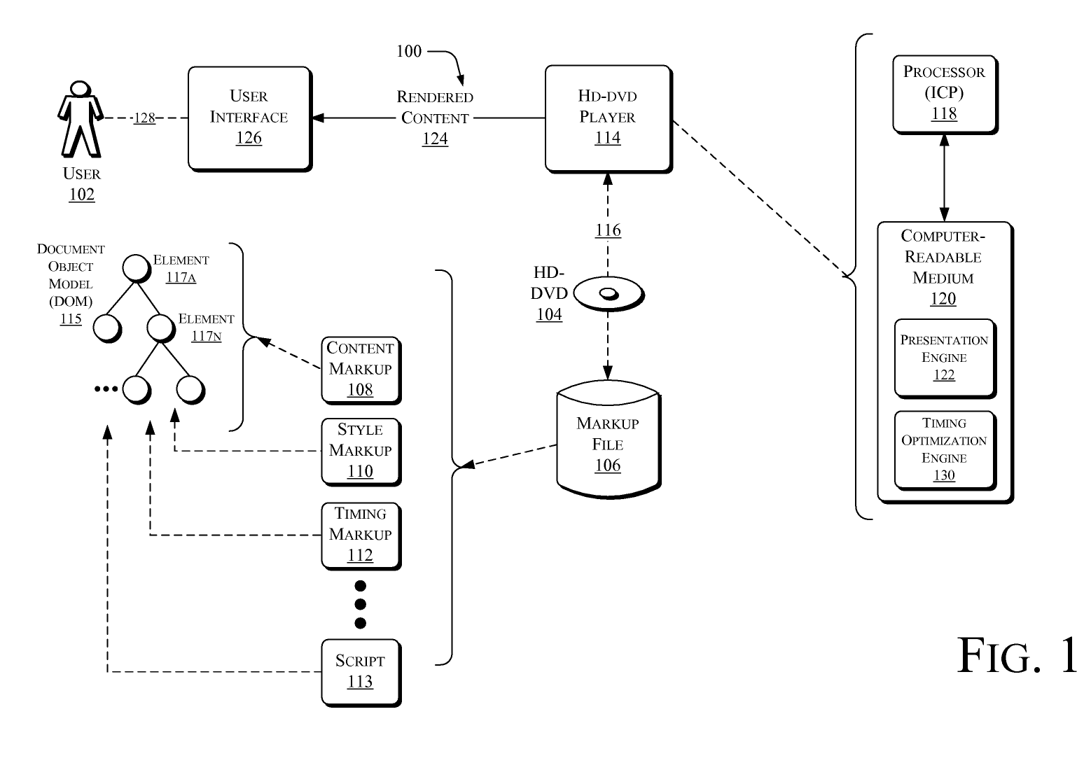

FIG. 1 illustrates operating environments 100 for optimizing execution of HD-DVD timing markup. The operating environments 100 may enable one or more users 102 to playback one or more HD-DVD disks 104. These HD-DVD disks 104 may include one or more machine-readable software components. These components may include, for example, one or more markup files 106. The markup files 106 may be implemented as a declarative XML-based language, and may include different vocabularies or markup components.

Examples of the markup files may contain at least content markup 108, style markup 110, and timing markup 112. Content markup 108 is contained within the main <body> section of a given markup document, and describes the overall layout structure of the objects or elements defined within the markup. Table 1, presented below, illustrates a tree of example HD-DVD content markup elements.

TABLE 1

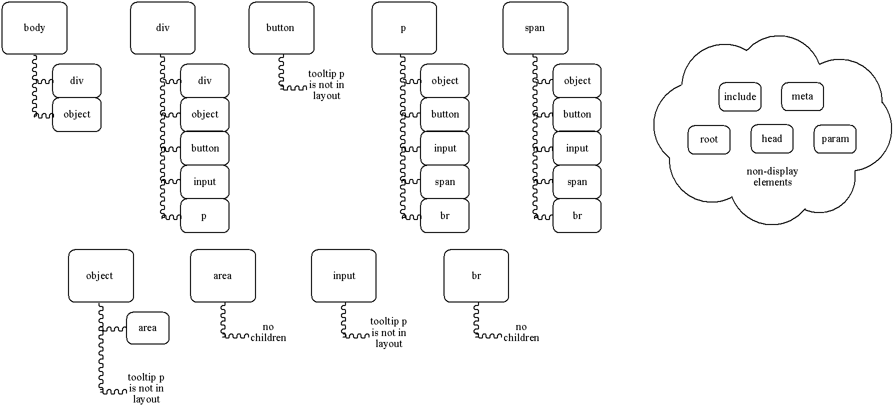

Style markup 110 is a vocabulary that describes how the objects or elements can be formatted. The style markup portion 110 may include an XML vocabulary that describes how the elements that are included in the content mark up portion 108 are to appear when presented to the user. Put differently, the content mark up portion may specify what elements are rendered to the user; the style markup portion may specify how these elements are rendered to the user.

Timing markup 112 is a vocabulary that describes how the content can be modified over time and via interactivity with the user. HD-DVD Timing markup as described herein is a subset of the industry standard SMIL language, but adds extensions that enable the SMIL language to be included outside of the <body> section of the markup document. For example, the timing markup described herein adds a special timing container called a “cue,” not defined by SMIL, that defines the elements in the markup document to which an animation property applies.

The content mark up portion, the style markup portion, and the timing markup portion may be implemented in a declarative programming language. However, a script portion 113 may be implemented in an imperative programming vocabulary that causes non-deterministic changes in the style markup over time.

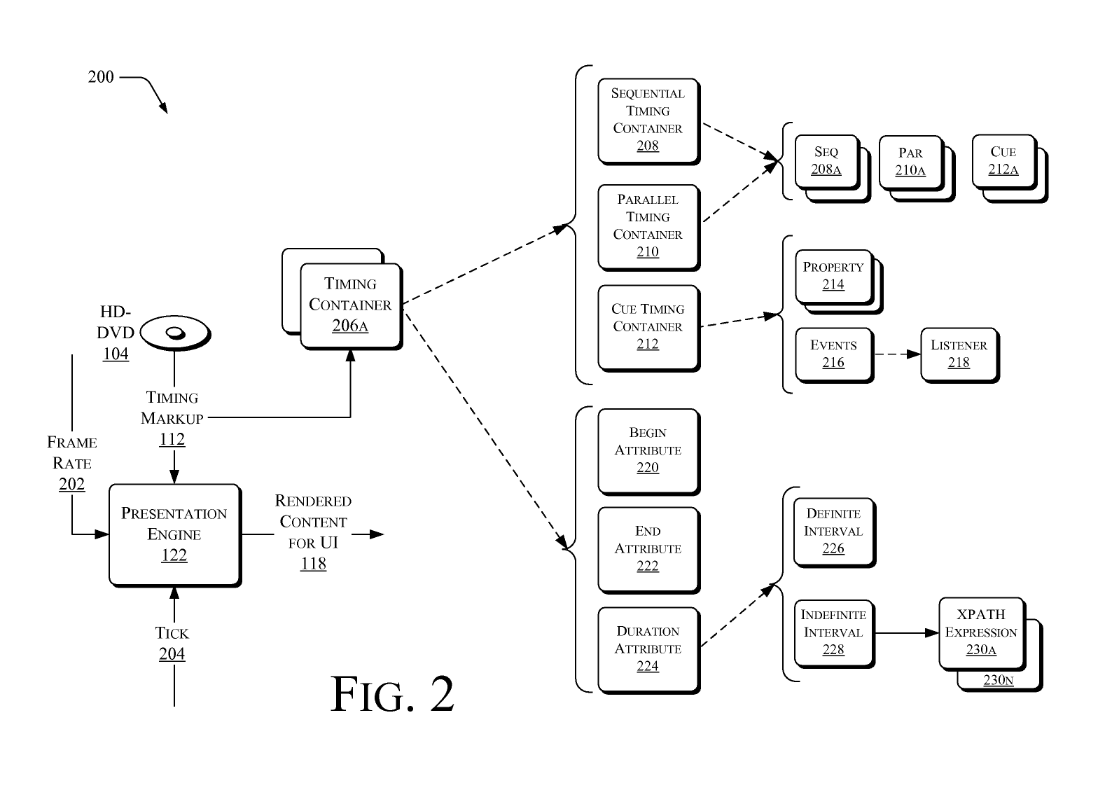

Taken as a whole, the content markup 108, the style markup 110, and the timing markup 112 define a document object model (DOM) 115. The DOM 115 may be implemented as a tree data structure using an XML vocabulary. The DOM may include a plurality of individual markup elements, denoted generally in FIG. 2 at 117. Table 1 above depicts sets of legal parent-child element combinations, providing specific examples of DOM states 115.

FIG. 1 shows two examples of the markup elements at 117a and 117n. However, implementations of the DOM may include an arbitrary number of elements 204, and the DOM tree may take any suitable form. The script 113 may be an imperative programming language that changes the DOM non-deterministically.

HD-DVD includes an interactivity layer that defines, amongst other things, a way that HD-DVD advanced applications can interact with the user and an audio/video playback system. An example of such an interactivity layer is available from Microsoft Corporation under the trademark HDi™. The HDi™ interactivity layer is encoded as a collection of data formats defined as Advanced Application content. These formats provide a declarative description of the content and may be derived from XML.

The operating environments 100 may enable the users 102 to insert the HD-DVD disks 104 into an HD-DVD player 114 for playback, as represented by the dashed line 116. The HD-DVD player 114 may be a computer-based system that includes one or more processors, denoted at 118. These processors 118 may also be categorized or characterized as having a given type or architecture, but may or may not have the same type or architecture. In possible implementations, the processors may include one or more interactive command processors (ICPs).

The HD-DVD player may also include one or more instances of machine-readable or computer-readable storage media, denoted generally at 120. The computer-readable media 120 may contain instructions that, when executed by the processor 118, perform any of the tools or related functions that are described herein as being performed by any component within the HD-DVD player. The processor may access and/or execute the instructions embedded or encoded onto the computer-readable media, and/or may access data stored in the computer-readable media.

Turning in more detail to the computer-readable media 120, it may include one or more instances of a HD-DVD presentation engine 122. The HD-DVD presentation engine 122 may include, for example, one or more software modules, which when loaded into the processor and executed, cause the HD-DVD player to load markup and other elements from the HD-DVD disk 104, including the timing markup 106. The presentation engine 122 may format and map the markup read from the HD-DVD disk into rendered content suitable for display to the user. FIG. 1 denotes this rendered content generally at 124.

As shown in FIG. 1, the HD-DVD player 114 may provide a user interface 126, through which the user 102 may interact with the HD-DVD player. The user interface 126 may include hardware provided by the HD-DVD player, or may include hardware provided by another device, for example, a television set or display screen to which the HD-DVD player is connected or coupled. Generally, the user interface 126 may represent any hardware and/or software components suitable for enabling the user to interact with the HD-DVD player. FIG. 1 generally represents interactions between the user 102 and the HD-DVD player 108 at 128.

The rendered content 124 may include menus, prompts, or other items that are generated by the presentation engine 122 to elicit response or input from the user. This response or input may include, for example, verbal or spoken commands, commands entered through a device (e.g., a remote control associated with the user interface 126 and/or the HD-DVD player 114), commands entered through buttons provided by the HD-DVD player, or any other suitable form.

Returning to the computer-readable media 120, it may include a timing optimization engine 130 that cooperates with the presentation engine 122 to optimize processing of the timing markup 112. As described throughout herein, the timing optimization engine 130 may employ one or more strategies to enable the presentation engine 122 to render content from the HD-DVD to the user at a sufficient frame rate to provide an acceptable user experience.

Having described the operating environments 100 with FIG. 1, the discussion now proceeds to a more detailed description of the presentation engine 122 and the timing markup 112, now presented with FIG. 2.

FIG. 2 illustrates additional aspects 200 of the presentation engine 122 and the timing markup 112. For convenience but not limitation, some elements described previously are carried forward into FIG. 2, and denoted by identical reference numbers.

The presentation engine 122 may operate at a frame rendering rate, denoted generally at 202. This frame rate 202 may be set by an author of the HD-DVD 104. More specifically, the author may specify a targeted frame rate in the markup. For example, the author may declare a desired frame rate in a file called a “playlist”. In another example, the author may declare a clock divisor on a per timing section basis. However, the HD-DVD specification does not guarantee that these targeted frame rates will be achieved when the timing markup is processed. The author may declare a targeted frame rate of 60 frames per section, but the implementation details of the HD-DVD software, coupled with the hardware platform on which the system is running, determine whether that targeted frame rate can be achieved. Accordingly, the optimizations described herein for processing the timing markup may increase the likelihood of achieving the targeted frame rate.

The presentation engine 116 may receive timing clock pulses or ticks, denoted generally at 204, that regulate or synchronize the processing, formatting, and rendering of the markup read from the HD-DVD. The HD-DVD player 108 may generate the ticks 204 using any suitable technology, provided that the ticks are generated to comply with the HD-DVD timing model.

Turning in more detail to the timing markup 106 as read from the HD-DVD disk 104, this markup may define one or more instances of timing containers 206. FIG. 2 provides two examples of the timing containers, denoted at 206a and 206n. However, it is noted that instances of the timing markup 106 may define an arbitrary number of timing containers 206.

The timing containers 206 may take different types or forms. In the example shown in FIG. 2, the timing containers may include sequential timing containers 208, or <seqs> for short. The timing containers may include parallel timing containers 210, or <pars> for short. The timing containers may include cue timing containers 212, or <cues> for short.

The <Par> and <Seq> time containers may contain one or more instances of child timing containers (i.e., <seqs> 208a, <pars> 210a, and <cues> 212a). The <Par> and <Seq> timing containers control when and how their respective children are evaluated. Children of a <par> timing container are processed in parallel, while children of a <seq> timing container are processed in sequence. <Cues> do not contain other time containers, but can contain one or more properties 214 that relate to the markup content, or may contain zero or more events 216 that can be signaled to a listener 218. The listener 218 may be implemented as JavaScript code that is written by the author of the HD-DVD application.

<Cue> timing containers 212a may contain particular events 216. More specifically, the timing containers may contain one or more attributes that define when the timing containers become active and inactive, and what specific nodes to which particular animation actions apply. Examples of animation actions include <animate>, <set>, and <event>. FIG. 2 shows three examples of timing-related attributes, denoted as a begin time attribute 220, an end time attribute 222, and a duration attribute 224.

Turning to these attributes in more detail, the begin time attribute 220 may specify when a particular time interval is to begin, and the end time attribute 222 may specify when a particular time interval is to end. The duration attribute 224 may be derived from the begin time attribute 220 and the end time attribute 222, or may be specified separately as a substitute for the attributes 220 and 222.

Recall from the discussion above that a timing container may be a <par>, a <seq>, or a <cue>. The timing containers include attributes that define when the containers are inactive or inactive (e.g., begin, end, dur). a <cue> can also include a “select” attribute that defines the nodes in the DOM to which given the animation actions apply. The attributes ‘begin’, ‘end’ and ‘select’ may use a time expression. The time expression may include a definite interval of time, or an XPATH expression (e.g., “id(‘myButton’)[state:focused( )=true( )]“).

Turning to the duration attribute in more detail, the timing container may in some instances specify the duration attribute in terms of specific time offsets. In these instances, the interval defined by such specific time offsets may be considered a “definite” interval, as represented at 226 in FIG. 2. Examples of definite intervals may include specified durations, such as 10 seconds, 20 milliseconds, or the like.

User interactivity and other changes to the DOM may have an impact on the duration of a time interval. For example, the “end” attribute of any timing container can be defined as an XPATH expression. The XPATH expression may query the DOM for specific changes to one or more properties that change because of user input, or because of changes made by the author in script (e.g., 113). In turn, these changes may impact the duration of the time container. In these instances, the interval defined by such specific time offsets may be considered an “indefinite” interval, as represented at 228 in FIG. 2. In some implementations, the timing containers may specify these indefinite intervals in terms of XML Path expressions, or XPATH expressions. FIG. 2 provides two examples of XPATH expressions, denoted at 230a and 230n (generally, 230). However, implementations of the timing containers may include any suitable number of XPATH expressions 230.

The following is an example of timing markup:

```
<par select=”id(‘mybutton’)” begin=”0s” dur=”2s”>
    <seq>
        <cue dur=”1s”>
            <set style:backgroundColor=”red”/>
            <event name=”myevent” />
        </cue>
        <cue dur=”1s”>
            <animate style:x=”0px;100px” />
            <set style:backgroundColor=”blue”/>
        </cue>
    </seq>
</par>
```

The above example defines a single par time container (e.g., 210) whose duration is a definite interval of 2 seconds, and whose related content nodeset is an element having an identifier id=‘mybutton’. This par time container contains a single seq time container (e.g., 208), which inherits a duration of 2 seconds from its parent par container.

The par time container contains two cue timing containers. The first cue time container executes for 1 second and sets the background color of the markup element ‘mybutton’ to red. The background color set by the first cue is an example of a property (e.g., 214) that may hold a presentation value. The first cue also fires an event (e.g., 216) named “myevent” when the first cue becomes active.

The second cue is activated after the first cue has completed, because the parent container of the first and second cue is a seq. The second cue executes for one second. While the second cue is active, it animates the x position of the markup element ‘mybutton’ from 0 to 100 pixels, and also changes the background color of the markup element ‘mybutton’ to blue. When these cues become inactive, the original property values of the background color are restored.

In some implementations of the timing containers, one XPATH expression may be nested within another XPATH expression. In other implementations, two or more intervals as defined by XPATH expressions may be arranged in parent-child relationships. In some such cases, the timing intervals may be “held”, meaning that the child interval maintains its last set of computed property values for the duration of a parent or other ancestor interval.

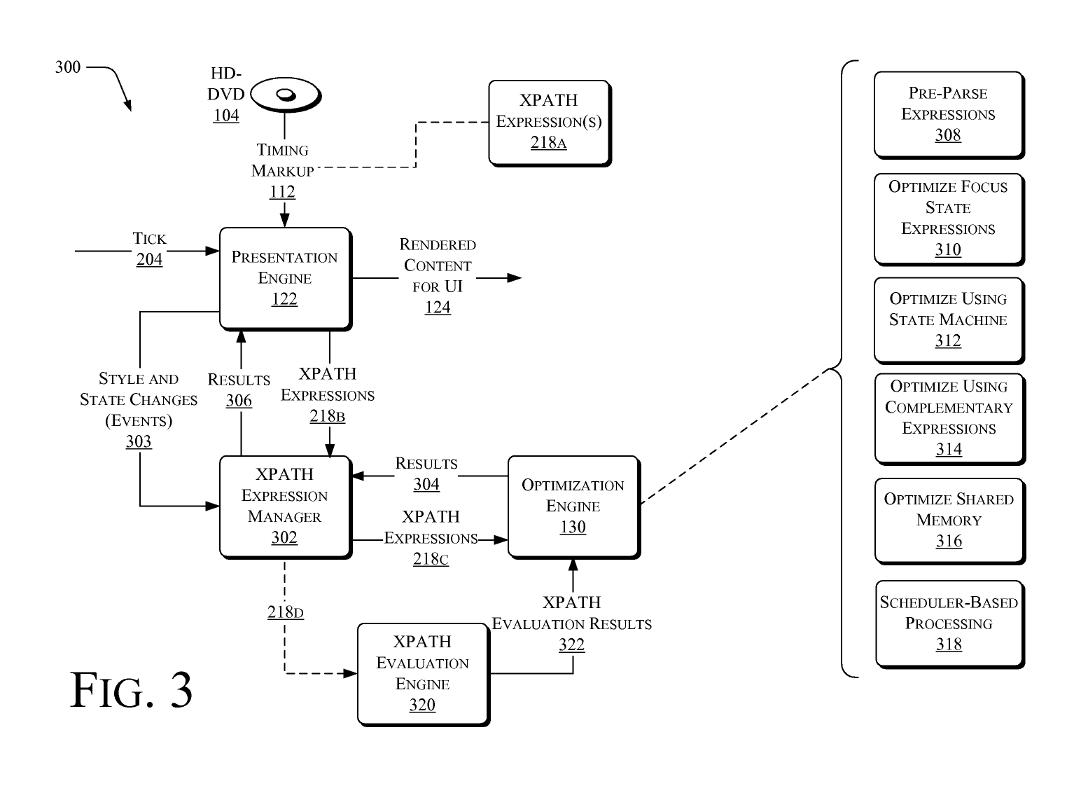

Having described the presentation engine and the timing markup in more detail with FIG. 2, the discussion now proceeds to a description of an XPATH expression manager and strategies for optimizing the processing of the timing markup, now presented with FIG. 3.

FIG. 3 illustrates aspects 300 of an XPATH expression manager and strategies for optimizing the processing of the timing markup. For convenience but not limitation, some elements described previously are carried forward into FIG. 3, and denoted by identical reference numbers.

As the presentation engine 122 processes elements read from the HD-DVD 104 in response to the ticks 204, it may encounter one or more XPATH expressions 218a in the timing markup 112. When the presentation engine locates XPATH expressions in the markup, the presentation engine may forward these XPATH expressions to an XPATH expression manager component 302 for processing and evaluation. FIG. 3 denotes at 218b the XPATH expressions as forwarded to the XPATH expression manager.

In addition, the XPATH expression manager may receive data representing style and state changes that occur as the timing markup 112 is processed. FIG. 3 denotes these style and state changes at 303. When a time interval becomes active, it contains a list of one or more animation actions to be applied while the interval is active and a specific targeted node-set for which these animation actions are to be applied. Animation actions include, for example, <set>, <animate>, <event>, and <link>. the following example is presented for ease of description, but not to limit possible implementations:

```
            <timing clock=“application”>
              <par>
                <cue select=“id(‘div2’)” begin=“id(‘animate1’)[state:actioned( )=‘true’]”
dur=“5s”>
                          <animate calcMode=“linear”
style:x=“200px;300px;400px;500px;600px;500px;400px;300px;200px” />
                  <set style:backgroundColor=“blue” />
                  <event name=“myEvent” />
                </cue>
              </par>
            </timing>
          <body style:font=“IYOPON.TTF”>
                  <div  id=“div2”  style:position=“absolute”  style:x=“200px”
style:y=“200px”  style:width=“50px”  style:height=“50px”
style:backgroundColor=“maroon”>
          </div>
          <div id=“buttons”>
                <input id=“animate1” style:width=“400px” style:height=“50px”
state:value=“linear” style:backgroundColor=“olive” />
          </div>
        </body>
```

The above example shows both the timing section and body section of an example markup file. The timing section includes two timing containers: a <par> and a <cue>. The <par> is undefined, but contains the <cue>, which animates the node-set associated by the “select” attribute. The “select” attribute is defined as a constant XPATH expression=id(‘div2’), which means the element whose id=div2. The ‘begin’ attribute of this <cue> is defined as an indefinite XPATH expression, and means that the <cue> becomes active when the actioned state of the element whose id=‘animate1’become true. Once this condition has been met, the time interval (in this case the <cue>) becomes active, and the time interval applies the animation actions that it contains. In this example, the animation actions include:

1) <animate>: interpolates the style:x position to the target node-set (in this case ‘div2’) over a range of values for the duration of the interval;

2) <set>: applies the value ‘blue’ to the style:backgroundColor property to the target node-set ‘div2’;

3) <event>: fires the event whose name is ‘myEvent’ to the target node-set ‘div2’ only at the point at which the interval is active. A listener function (e.g., 218) defined in script by the author may receive this notification, and can call any number of operations in script upon receiving this notification.

The XPATH expression manager component may include one or more software modules containing instructions for evaluating the XPATH expressions. Additionally, the XPATH expression manager 302 may forward the XPATH expressions 218 to the optimization engine 130, to determine whether the processing of the XPATH expressions 218 may be optimized. FIG. 3 denotes at 218c the XPATH expressions as forwarded to the optimization engine.

In some cases, the optimization engine may be able to optimize the processing of the XPATH expressions using one or more of the strategies described herein. In these cases, the optimization engine may return results 304 that result from optimized evaluation of the XPATH expressions. FIG. 3 shows an example in which the optimization engine returns these results 304 to or through the XPATH expression manager 302.

In some instances, the XPATH expressions 218 may not lend themselves to optimized processing using any of the strategies described herein. In these instances, the XPATH expression manager 302 may itself evaluate these XPATH expressions, returning values 306 to the presentation engine. The values 306 represent the results of non-optimized evaluations.

The optimization engine 124 may include software modules implementing one or more strategies for optimizing processing of the timing markup 106. FIG. 3 denotes these strategies in block form, and later drawings detail these strategies further.

As represented in block 308, one strategy may include pre-parsing and pre-computing at least some of the XPATH expressions that are defined in the markup read from the HD-DVD. A strategy, represented by block 310, may include optimizing processing for expressions that are dependent on focus state. A strategy, represented by block 312, may include optimizing processing by using a finite state machine. A strategy, represented by block 314, may include optimizing the processing of timing containers by recognizing and evaluating complementary expressions. A strategy, represented by block 316, may include optimizing the processing of timing containers by using a shared memory pool to store timing-related data structures. A strategy, represented by block 318, may include optimizing processing by using a scheduler.

While describing these various strategies 308-318 in more detail below, it is noted that implementations of the description herein may include one, some, or all of these strategies in combination, as appropriate. Also, these strategies may be implemented in separate software modules, or may be integrated into one or more common modules. Accordingly, it is noted that FIG. 3 shows these strategies in separate blocks only for ease of description and reference, but not to limit these possible implementations.

The optimization engine 130 may cooperate with an XPATH Evaluation engine 320 to re-evaluate any XPATH expressions that are not optimized using any of the optimization strategies 308-318. The XPATH Evaluation engine 320 may be compliant with HD-DVD XPATH syntax, which is a derivative of W3C XPATH 2.0. The XPATH Expression manager 302 may directly call the XPATH Evaluation Engine 320 to re-evaluate a given XPATH expression. A dashed line 218d in FIG. 3 represents this call and the XPATH expression provided as input to the XPATH Evaluation Engine 320. In turn, the XPATH Evaluation Engine 320 may generate evaluation results 322 and provide these results to the optimization engine.

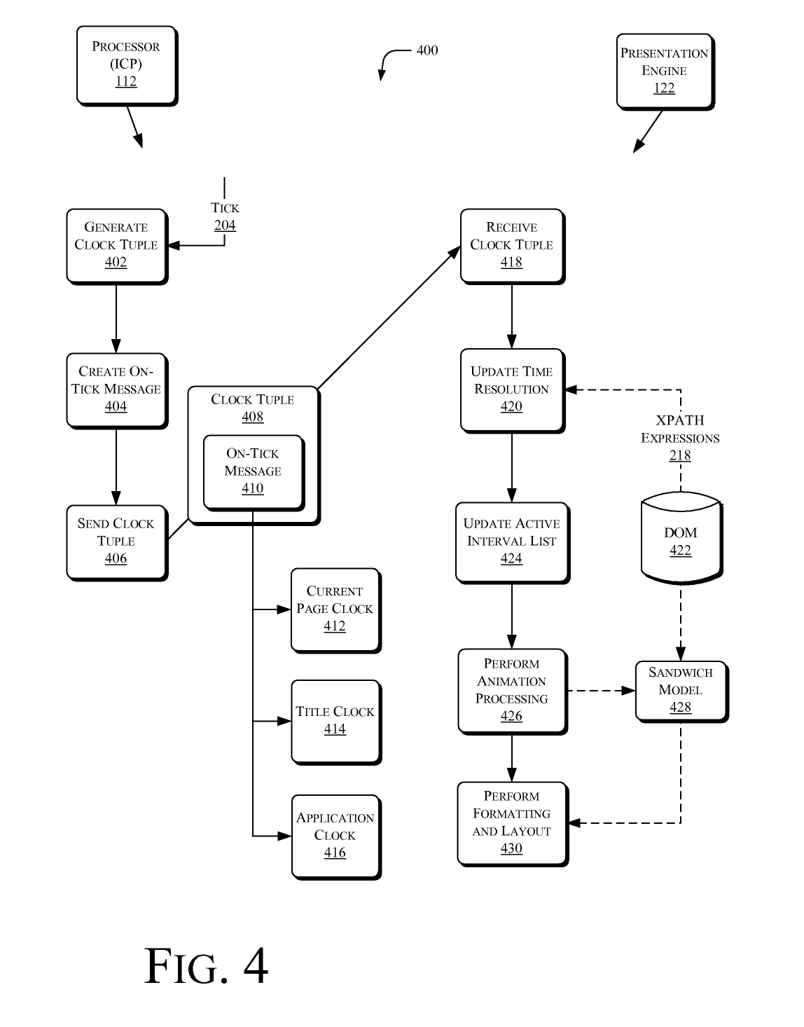

Having described the XPATH expression manager and several strategies for optimizing the processing of the timing markup with FIG. 3, the discussion now proceeds to a description of data and process flows for processing the timing markup, now presented with FIG. 4.

FIG. 4 illustrates data and process flows 400 for processing the timing markup. For convenience but not limitation, some elements described previously are carried forward into FIG. 4, and denoted by identical reference numbers. Additionally, FIG. 4 shows some aspects of the data and process flows 400 as being performed by certain components for ease of description, but not limitation.

Block 402 represents generating a clock tuple in response to receiving a clock pulse or tick (e.g., 204). The clock tuple may contain a title clock, page clock, and application clock values. As ticks occur, block 402 generates corresponding clock tuples. These clock tuples are synchronized to the same clock base. As shown in FIG. 4, a processor (e.g., ICP 112) may perform block 402. In some implementations, an oscillator or similar timing element that is on-board the processor may perform block 402. In other implementations, the oscillator or timing element may be external to the processor.

Block 404 represents include creating and sending an on-tick message in response to the clock pulse. This on-tick message provides a notification mechanism to the rest of the process elements shown in FIG. 4, indicating that a clock pulse has occurred.

Block 406 represents sending the clock tuple created in block 402 to, for example, a presentation engine (e.g., 116). FIG. 4 denotes the clock tuple as sent to the presentation engine at 408. The clock tuple 408 may include the on-tick message, which is denoted at 410. The on-tick message 410 may include, for example, one or more of a current page clock value 412, a title clock value 414, and an application clock value 416.

At the presentation engine, block 418 represents receiving the clock tuple 408. Block 420 represents performing time resolution for the tick represented in the input clock tuple. In performing block 420, the presentation engine may query a data structure such as a document object model (DOM) 422. The DOM 422 may contain, for example, content markup, style markup, script, and the timing markup 106, as encoded onto and readable from an HD-DVD disk (e.g., 104). The DOM may be implemented as a tree data structure using an XML vocabulary.

The DOM 422 may store one or more XPATH expressions (e.g., 218) that become relevant for processing as ticks 204 occur. The DOM may provide these XPATH expressions 218 in response to queries from the presentation engine, as indicated by the dashed line connecting blocks 422 and 420 in FIG. 4.

Block 424 represents updating an active animation list in response to the clock tuple. More specifically, block 424 may include updating an active interval list for the new clock tuple. To reduce overall processing overhead, previous results may be cached, and only changes arising from the new clock tuple are reflected in the active interval list. As timing intervals become active, they are added to the active interval list; conversely, when timing intervals become inactive, they are removed from the active interval list.

The active interval list indicates which intervals are active. Put differently, block 424 may include determining which timing intervals specified in the XPATH expressions are or become active at a given tick. Timing intervals that are active at a given time are referred to as “active intervals”.

Block 426 represents performing animation processing, which may include evaluating the active intervals and calculating new presentation values for the active intervals. Values of these intervals may be layered, such that layers may be combined or obscured in various ways. The term “presentation value” refers to the net or effective value for a given point in time. The presentation value is made tangible to the user during a given interval, although other values may be associated with this interval, hidden in the layering and/or combined to contribute to this overall, presentation value. Block 426 may include calculating these new presentation values based on a sandwich model, as denoted generally at 428. The sandwich model may specify presentation values for given ticks, and may specify dynamic properties associated with respected nodes in the layout section of the DOM.

Block 430 represents performing formatting and layout operations for the presentation values resulting from block 426. Block 430 may include specifying the formatting and layout using extensible stylesheet language (XSL).

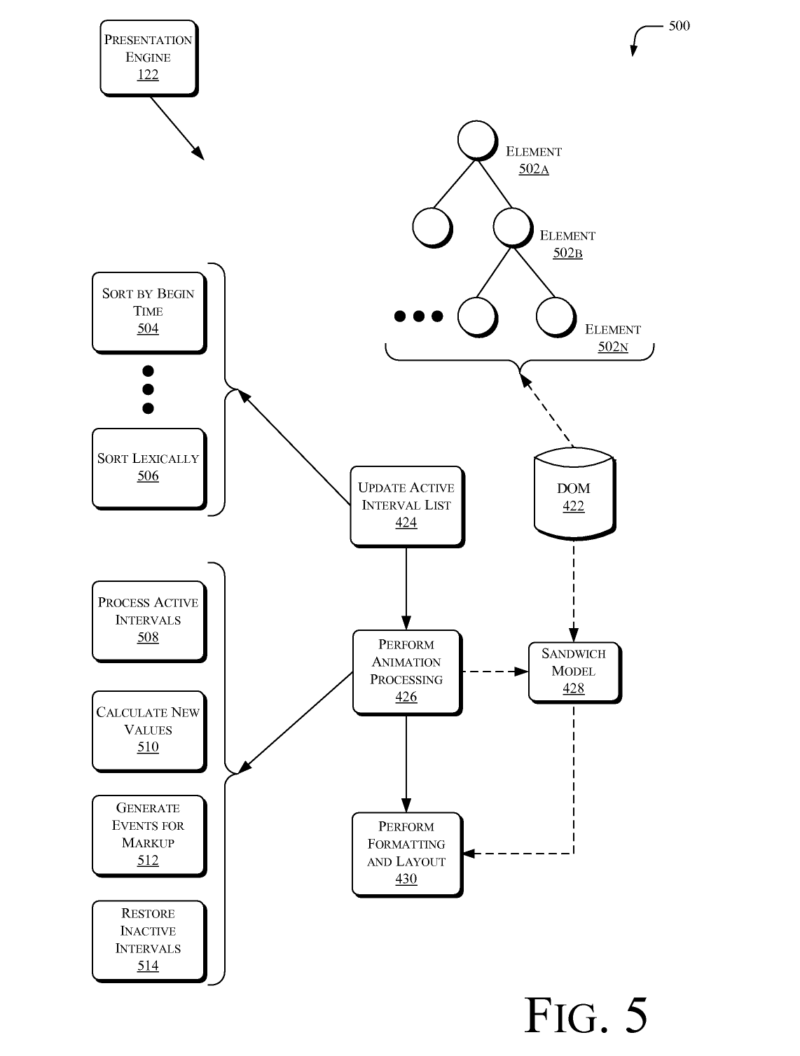

Having described the data and process flows for processing the timing markup with FIG. 4, the discussion now proceeds to a description of additional details relating to some aspects of these data and process flows, now presented with FIG. 5.

FIG. 5 illustrates additional aspects 500 of the data and process flows shown in FIG. 4. For convenience but not limitation, some elements described previously are carried forward into FIG. 5, and denoted by identical reference numbers.

As shown in FIG. 5, the DOM 422 may include a plurality of individual markup elements, denoted generally in FIG. 5 at 502. FIG. 5 shows three examples of the markup elements at 502a, 502b, and 502n. However, implementations of the DOM may include an arbitrary number of elements 502, and the DOM tree may take any suitable form. These markup elements may define a scene description for what is rendered on-screen to the user.

As described in FIG. 4, block 424 represents generating an active animation list, which may include a plurality of timing containers. Block 424 may include sorting the timing containers in the active animation list by begin time attributes (e.g., 208 in FIG. 2), as represented by block 504. Block 424 may also include lexically sorting the timing containers in the active animation list, as represented by block 506.

Sorting or ordering of timing intervals may be done “in-place” using appropriate data structures. Using the techniques described herein, all active timing intervals need not be re-sorted or re-ordered on each clock tick. For example, the data structures may track the last time and timing interval that was added the active interval list. The data structures may contain statistical evidence that has driven the processes 400 and 500 to, by default, add the latest timing interval to the end of the active interval list. In only exceptional cases, the processes may look back further in the active interval list to locate the proper insertion point for the new timing interval. Typically, the proper insertion point is in near proximity to the most recently added interval. However, locating this insertion point may be based on previous statistical analysis of a body of HD-DVD timing markup.

Turning to block 426, this block may further represent processing active intervals included in the active animation list, as represented in block 508. Block 426 may also include calculating new presentation values for the current tick, as represented by block 510. Block 426 may include generating markup-specific events, as represented by block 512. Finally, block 428 may include restoring any inactive timing intervals, as represented by block 514.

Using the tools and techniques shown herein, the processes 400 and 500 may optimize the processing of XPATH expressions. Optimizing the processing of the XPATH expressions as described herein may achieve faster frame rates and provide better user or viewer experiences when interacting with HD-DVD content.

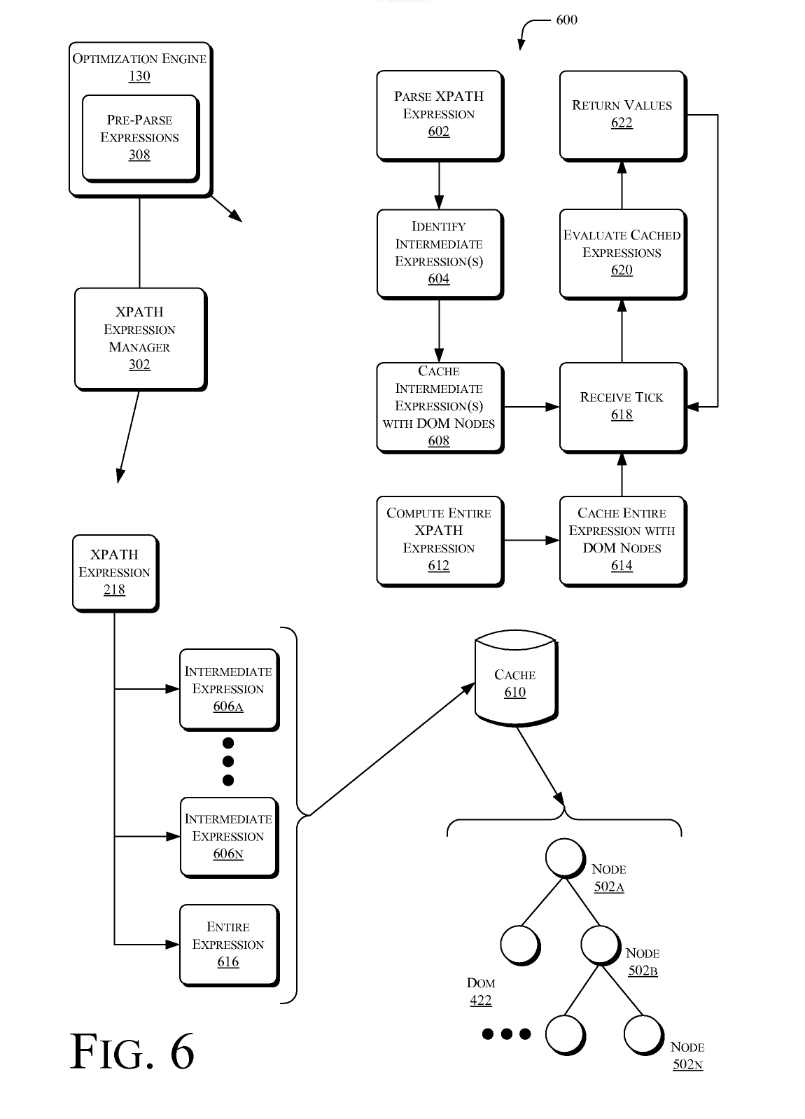

Having described additional aspects of these data and process flows with FIG. 5, the discussion now proceeds to a more detailed description of the optimization strategies, beginning with FIG. 6.

FIG. 6 illustrates components and process flows 600 related to optimization strategies involving pre-parsing and pre-computing certain XPATH expressions. For convenience but not limitation, some elements described previously are carried forward into FIG. 6, and denoted by identical reference numbers.

As shown in FIG. 6, an optimization engine (e.g., 124) may include software components suitable for pre-parsing and pre-computing certain XPATH expressions. FIG. 3 denotes examples of such software components at 308 in FIG. 3, and block 308 is carried forward into FIG. 6. The optimization engine may cooperate with an XPATH expression manager (e.g., 302).

FIG. 6 shows process flows 600 for optimizing processing of the XPATH expression by pre-parsing and pre-computing. Block 602 represents parsing an input XPATH expression as received by the XPATH expression manager. FIG. 6 carries forward an example of an XPATH expression at 218.

Block 604 represents identifying one or more intermediate XPATH expressions occurring within the input XPATH expression 218. FIG. 6 denotes two examples of these intermediate expressions at 606a and 606n. However, any number of intermediate expressions 606 may occur in a given XPATH expression 218.

Block 608 represents caching the intermediate expressions 606, and associating them with corresponding elements or nodes within the DOM tree. The DOM tree 422 and related nodes 502 are carried forward into FIG. 6. A cache 610 may store the DOM tree and related nodes.

Block 612 represents computing a result for the entire XPATH expression, as distinguished from computing results for the intermediate expressions that may constitute the entire XPATH expression. As described shortly in more detail, on some clock ticks, none of the intermediate XPATH expressions may change values, so the value of the entire XPATH expression remains constant.

Block 614 represents caching a value for the entire XPATH expression. In instances where the value of the entire XPATH expression remains constant after a given tick, the previous value of the entire XPATH expression may then be retrieved from the cache.

It is noted that blocks 602-608 may be performed in parallel with blocks 612-614. In this manner, the entire XPATH expressions may be parsed into intermediate expressions (e.g., 606a and 606n), and values computed and cached for the various intermediate expressions. Meanwhile, values for the entire XPATH expressions may be computed and cached, as represented by block 616.

Block 618 represents receiving a tick or other timing event. In response to the tick, block 620 represents evaluating the pre-parsed and pre-computed intermediate expressions (e.g., 606) as stored in the cache. Block 620 may also include evaluating the pre-computed entire expressions (e.g., 616) as stored in the cache. Block 622 represents returning the values resulting from the evaluation performed in block 620. Afterwards, the process flow 600 may return to block 618 to await the next tick.

In the techniques shown in FIG. 6, the intermediate expressions completely resolve each XPATH axis to a canonical form that may include a binary representation of a node-set, a binary list of operators, and a binary representation of a predicate filter. All but the predicate filter may be fully resolved, meaning that the intermediate expression has been fully parsed, axis node-sets reference a referential data structure representing the list of DOM nodes in the axis, and predicate filters have converted the original string data in its declarative form to a simpler binary form that can be efficiently evaluated without requiring re-interpretation.

Caching these expressions may be done with different mechanisms, including storing a reference to the parsed expression on a data structure/object that encapsulates a time interval node. The XPATH expressions may be parsed, pre-computed, and converted to a binary canonical form at load time, or at any point prior to the continual on-tick/layout operation. It is noted that this operation is done only once for a given DOM, and is redone only if the DOM mutates. Once the XPATH expression is parsed and at least partially resolved (in some cases fully resolved), the expression manager may evaluate the expression only on the predicate filter, which also has been simplified.

Consider the following example:

<cue begin=”//button[style:backgroundColor( )=’red’]” dur=”500ms”
. . . >

The XPATH expression ‘//button[style:backgroundColor( )=‘red’]’ means to query all of the elements in the XML DOM whose element name is “button”, and of that set, return any whose current computed value of the style:backgroundColor property is equal to the value ‘red’.

In a typical environment, this expression may first be parsed, then evaluated afterwards. The parsing phase converts the original string into a series of one or more tokens, and stores them into a referential data structure that describes a more simple and efficient form of the original string expression. Typically, a recursive descent parsing algorithm may be used to parse the expression. However, other parsing algorithms and approaches can be used.

One process that may be performed during the parsing phase is axis resolution. Axis resolution refers to a process of creating one or more node-sets on which zero or more of the predicate filters will operate. As each time interval parses its indefinite XPATH expression, the interval maintains a reference to the parsed and partially resolved expression. Typically, this reference eliminates any need to perform this parsing phase again, unless the underlying DOM mutates (which is usually infrequent in HD-DVD applications).

Once the parsing phase has been completed, the simpler and more efficient binary data structure is used for the second phase, which is expression evaluation. Expression evaluation is performed on a simpler data structure and involves only resolving and producing results based on zero or more predicate filters. The predicate filters are also represented in a binary canonical form, thus reducing the processing overhead related to expression evaluation.

Under the scheme shown in FIG. 6, the time-consuming and processing-intensive task of parsing the XPATH expressions is only done once, and the intermediate expression is partially (or in some cases fully) resolved. These optimizations may significantly reduce the processing overhead associated with processing and evaluating XPATH expressions.

Having described the optimization strategies involving pre-computing expressions with FIG. 6, the discussion now proceeds to a more detailed description of optimization strategies involving event-driven expressions.

Turning to the optimization strategies involving event-driven expressions in more detail, FIG. 3 illustrated optimization strategies involving event-driven expressions at 310, which may be provided by the optimization engine 124. These optimization strategies may include separating indefinite expressions into expressions that may be driven by or dependent on the occurrence of events, as distinguished from expressions whose underlying values may be determined by polling. For example, timing containers (e.g., par, seq, and cue) may use the HD-DVD state namespace to define when their respective intervals become active or inactive. Interactive states (e.g., state:foreground, state:focused, state:pointer, state:actioned, state:value, and state:enabled) may be driven primarily from events that the user originates via a controller. These event-driven events may be handled out of band from processing the timing markup. These events or state transitions may be used to trigger an event-driven mechanism that may eliminate or reduce the number of expression evaluations that are performed per-tick.

The HD-DVD specification defines a model for how controller events or “gestures” are propagated to the presentation engine. These events may be sent out of band from “tick” processing, and may affect the “state” namespace of the markup DOM. The HD-DVD specification defines the “state” namespace differently from the “style” namespace from the standpoint of the sandwich model, in that changes to “state” immediately change the underlying attribute in the DOM.

Since state values are handled out of band from tick and layout processing, the process of handling gesture events may be related to the data structures that manage the animation list that is subsequently handled during on-tick processing. As a state value is changed, it can be directly linked to any XPATH expressions that are waiting for resolution of this state change.

Consider the following cue that contains a begin XPATH expression:

<cue begin=”id(‘myButton1’)[state:focused( )=1]” . . . >

This cue declares that it should begin when the state:focused attribute is set to “one” for the element whose unique name is ‘myButton1’. Gesture processing logic within the presentation engine may manage user input and subsequent state management. Rather than continually polling the XPATH engine for when this expression becomes true, the gesture processing logic may have predetermined knowledge that allows it to resolve the XPATH expression, without evaluating the XPATH expression, thereby avoiding the overhead of evaluating the XPATH expression.

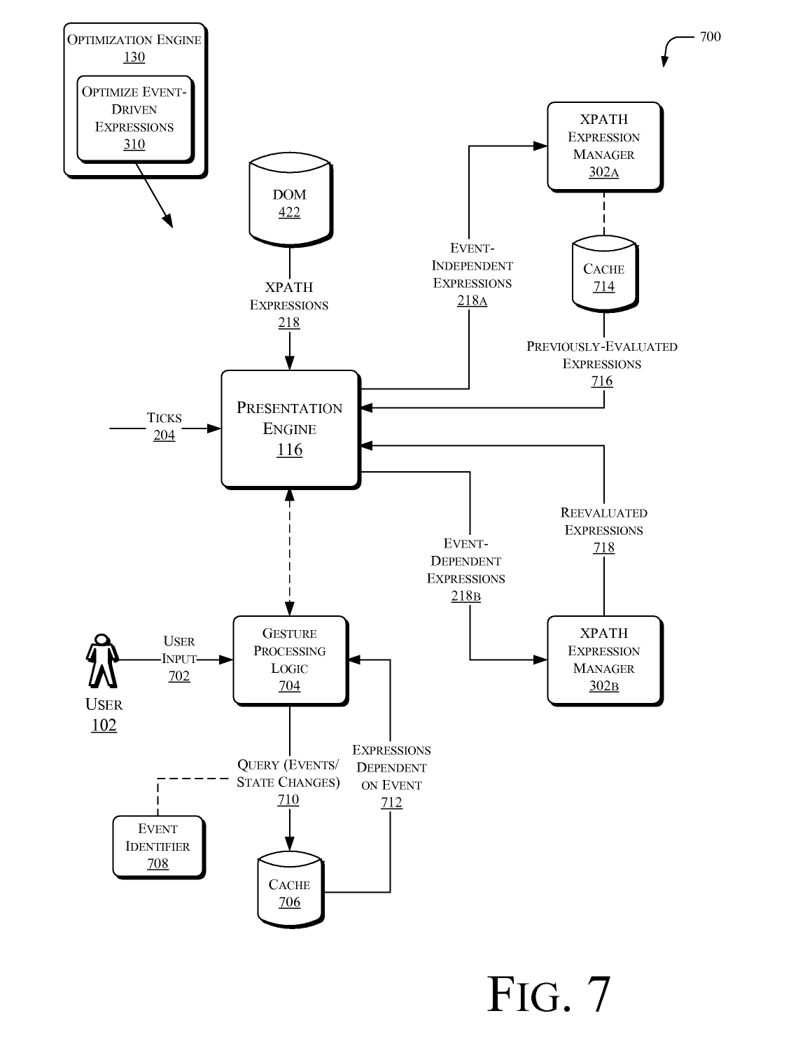

Having described pre-processing relating to optimizing event-driven expressions, the discussion now proceeds to a description of processing that may be performed as events occur, presented with FIG. 7.

FIG. 7 illustrates components and flows 700 related to optimizing event-driven expressions. For convenience but not limitation, some elements described previously are carried forward into FIG. 7, and denoted by identical reference numbers.

The terms “event” or “events” as used herein may refer to changes to style and state resulting from user input, as well as changes to style and state that result from animation and/or from script. More specifically, the XPATH expression manager (e.g., 302) establishes a relationship with the presentation engine (e.g., 122), under which the XPATH expression manager accepts changes to state and style properties resulting from author-defined script code, user input, or animation as described above. In other words, script code may modify zero or more property values (both state and style), user input may change the state of any interactive element, and animation (i.e., processing of timing elements) may result in the change of state and style of elements. The XPATH Expression manager accepts these inputs, and manages and updates its internal cache of XPATH expressions accordingly.

As described previously, a user (e.g., 102) may provide input to the HD-DVD player (e.g., 108 in FIG. 1). For example, the user may enter commands, or respond to prompts or menus displayed by a presentation engine (e.g., 116). FIG. 7 generally denotes such user input at 702, and may include spoken commands, commands entered via a remote control device or via buttons on the HD-DVD player, or the like. The presentation engine may include or cooperate with gesture processing logic 704 that receives and processes the user input 702.

The gesture processing logic 704 may recognize particular events that occur in response to the user input 702, and may query a cache 706 with identifiers corresponding to these events. FIG. 7 provides examples of such identifiers at 708. FIG. 7 denotes these queries at 710. In turn, the cache 706 may return any fields matching the input event identifiers 708. If the input event identifiers match any fields or records in the cache, the cache may return any evaluated expressions 712 associated with the matching fields or records. The expressions 712 include those expressions whose value may change in response to events resulting from the user input 702.

Turning to the presentation engine, as ticks 204 occur, the presentation engine 116 may receive XPATH expressions 218 from the DOM 422 in response to those ticks. The presentation engine 116 may compare the XPATH expressions 218 to any event-driven or event-dependent expressions 712 that were returned from the cache 706. This comparison identifies those XPATH expressions whose evaluations are independent of events resulting from the user input 702, as well as identifying those XPATH expressions whose evaluations may change because of such events. The former may be termed as event-independent expressions, and are denoted at 218a. The latter may be termed as event-driven or event-dependent expressions, and are denoted at 218b.

Turning now to the event-independent expressions 218a, the values or evaluations of these expressions do not change because of the user event(s). Thus, if previous values of such expressions have cached previously (e.g., in a cache 714), these previous values would remain unchanged, current, and correct. Accordingly, the presentation engine 116 may forward these event-independent expressions 218a to an instance of the XPATH expression manager, denoted at 302a. The XPATH expression manager 302a may retrieve the previous values of these event-independent expressions from the cache 714. The XPATH expression manager 302a may then forward values for these evaluated expressions (denoted at 716) to the presentation engine for use.

Turning now to the event-dependent XPATH expressions 218b, these expressions may change values or evaluations because of the user input 702. In these cases, the presentation engine 116 may forward any event-dependent expressions 218b to an instance of the XPATH expression manager, denoted at 302b, that re-evaluates the event-dependent expressions 218b, and returns updated values for these re-evaluated expressions, denoted at 718.

FIG. 7 shows the different instances of the XPATH expression managers only for ease of illustration and reference, but not to limit possible implementations. More specifically, in some implementations, a single XPATH expression manager 302 may process both the event-independent expressions 218a and the event-dependent expressions 218b.

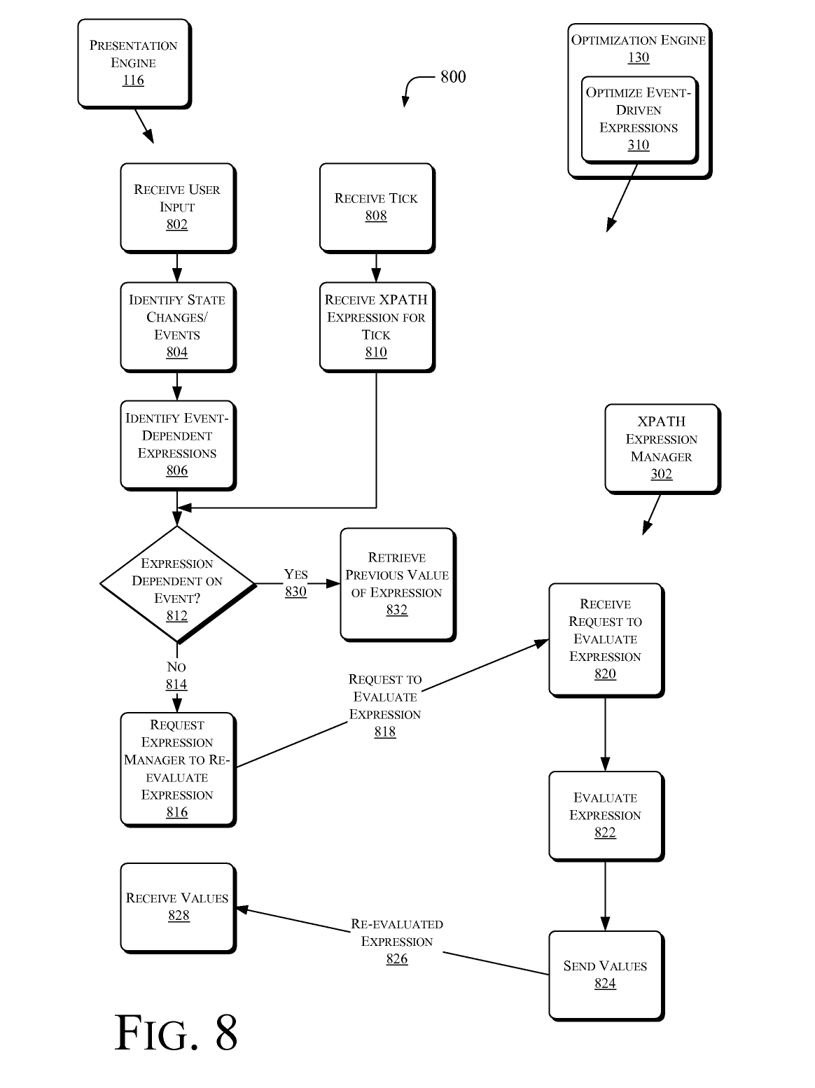

FIG. 8 illustrates process flows 800 for optimizing processing of event-dependent or event-driven expressions. FIG. 8 shows in flowchart form the processing illustrated and described in connection with FIG. 7. For convenience but not limitation, some elements described previously are carried forward into FIG. 8, and denoted by identical reference numbers.

Additionally, for ease of description, but not limitation, FIG. 8 arranges some processing elements in columns corresponding to a presentation engine (e.g., 116) and an optimization engine (e.g., 124). The optimization engine may include software components related to optimizing the processing of event-driven expressions (e.g., 310).

Block 802 represents receiving input from a user. FIG. 7 shows an example of a user at 102, and provides an example of input received from the user at 802.

Block 804 represents identifying any state changes or events that result from the user input received in block 802. Block 804 may include identifying any events that may correspond to pre-defined event identifiers (e.g., 708 in FIG. 7). These pre-defined event identifiers may enable identification of any XPATH expressions whose values may change as a result of these events.

Block 806 represents identifying event-driven or event-dependent expressions. Block 806 may include querying a cache of event identifiers that are related to corresponding XPATH expressions whose values may change if one or more underlying events occur. FIG. 7 provides examples of such a cache at 706, along with event identifiers 708 and event-dependent expressions 712.

Block 808 represents receiving an indication of that a tick or other timing input has occurred. FIG. 7 and other drawings herein show examples of ticks at 204.

Block 810 represents receiving one or more XPATH expressions in response to the tick received in block 808. FIG. 7 and other drawings show examples of XPATH expressions at 218, and block 810 may include receiving these XPATH expressions from a DOM (e.g., 422 in FIG. 7).

It is noted that the processing represented in blocks 802-806 may proceed in parallel with the processing represented in blocks 808 and 810. In this manner, the process flows 800 may process incoming user events while also processing input timing ticks.

Block 812 represents evaluating whether the XPATH expressions received in block 810 are dependent on any events resulting from the user input received in block 802. If the XPATH expressions are event-driven or event-dependent, then the values of these expressions may have changed because of events relating to the user input received in block 802. Accordingly, the process flows 800 may take Yes branch 814 to block 816, which represents requesting that any event-driven XPATH expressions be re-evaluated in light of the occurrence of the user events. Block 816 may include requesting that an XPATH expression manager (e.g., 302) reevaluate the expression. FIG. 8 represents this request at 818.

Turning to the XPATH expression manager 302, block 820 represents receiving a request to evaluate an XPATH expression. Block 820 may include receiving a request to reevaluate an XPATH expression that is event-dependent or event-driven.

Block 822 represents evaluating one or more XPATH expressions in response to the request 818. Block 822 may include reevaluating one or more event-driven XPATH expressions in response to the occurrence of one or more events.

Block 824 represents sending the values that result from reevaluating the expression in block 822. Put differently, block 824 represents updating the values of expressions to account for the occurrence of any events on which the expressions depend. FIG. 8 denotes these results of reevaluating the expressions at 826.

Block 828 represents receiving the results of reevaluating the expressions in block 824. In the example shown in FIG. 8, the presentation engine may perform block 828.

Returning to evaluation block 812, if the input XPATH expression is not dependent on a user event, then the process flows 800 may take No branch 830 to block 832, which represents retrieving a previous value of the expression. For example, block 832 may include retrieving the results of previously evaluating the expression, as stored in a cache (e.g., 714). In this manner, the process flow 800 may avoid the processing represented in blocks 816-828 for any XPATH expressions whose values do not depend on the occurrence of underlying user events.

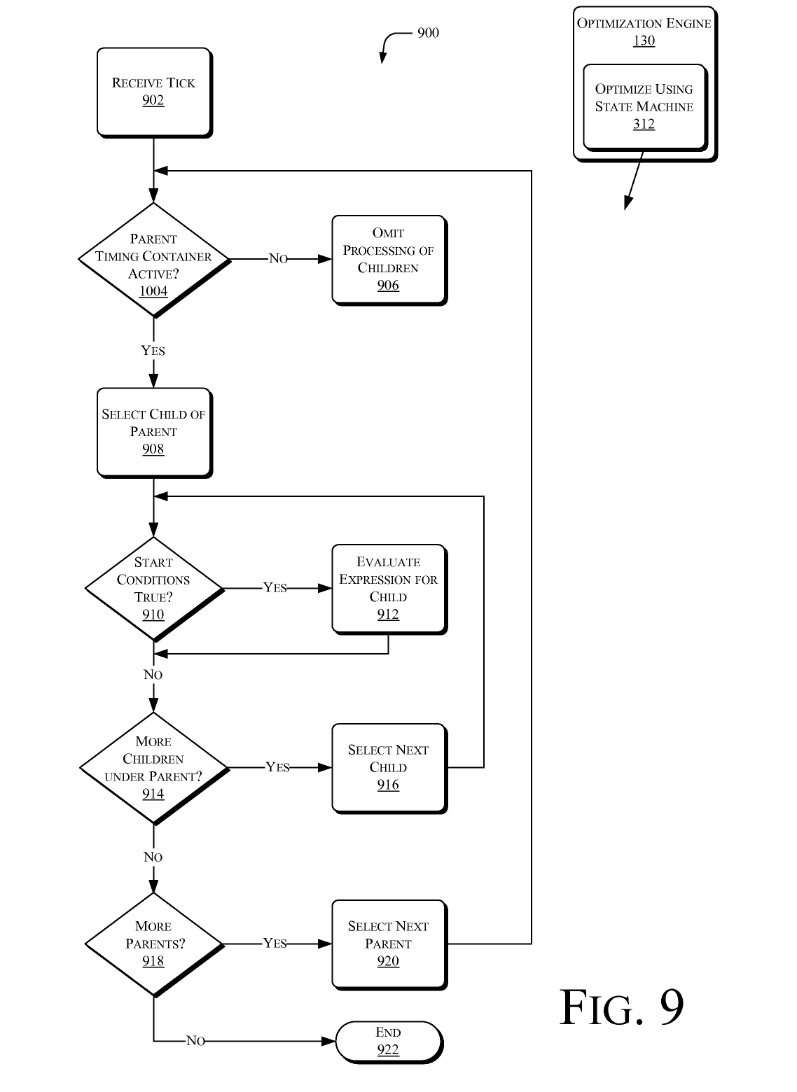

Having described the process flows 800 in FIG. 8 for optimizing the processing of event-driven expressions, the discussion represents to a description of optimization techniques using finite state machines, now presented with FIG. 9.

FIG. 9 illustrates optimization techniques 900 using finite state machines. For convenience but not limitation, some elements described previously are carried forward into FIG. 9, and denoted by identical reference numbers.

FIG. 9 provides further description of processing related to optimization techniques involving finite state machines, represented generally at 312. The optimization engine 124 may provide these optimization techniques.

A finite state machine as described herein provides a mechanism that may be embedded into an animation engine to efficiently process various timing intervals and their related ancestors. The basic states are inactive, active and hold. Intermediate state variables within a given timing interval may include restartable, indeterminate, and resolved. The state variables may also include any specified begin, end, and duration attributes (if applicable). FIG. 2 shows examples of such attributes at 220, 222, and 224.

Employing this state machine mechanism within the animation engine enables efficient processing of the time intervals within a specific time sheet because it facilitates skipping complete sub-trees of timing intervals. Without limiting possible implementations, the term “time sheet” as used herein may refer to a container of timing elements that are all synchronized to the same time base. Additionally, if a given parent time interval becomes inactive, then all of its children become inactive and restartable. The state machine may also track the restartable state of a given time interval.

As shown in FIG. 9, block 902 represents receiving an indication of at least one tick, timing pulse, or other clock-related event. Block 904 represents evaluating whether a parent timing container within a given XPATH expression is active. If not, block 906 represents omitting processing of any children of the parent timing container. Otherwise, if the parent timing container is active, then block 908 represents selecting a child timing container of the parent for processing.

Block 910 represents evaluating whether any start conditions specified in the child timing container are true. If so, then block 912 represents evaluating any expressions specified in the child timing container. Otherwise, block 914 represents evaluating whether the parent timing container has any more children yet to be evaluated. If so, then block 916 represents selecting a next child timing container for processing. Afterwards, the process 900 returns to before block 910 to repeat the process with this next child.

From block 914, if the parent timing container has no more children, then block 918 represents evaluating whether any more parent timing containers remain to be evaluated. If so, then block 920 represents selecting a next parent timing container for processing. Afterwards, the process 900 returns to before block 904 and repeats the process with this next parent.

From block 918, if there are no more parent timing containers, then the process 900 may reach an end state 922.

The foregoing processes 900 may be implemented as one or more finite state machines that perform the functions illustrated and described therein.

Other optimization techniques, represented generally at 314 in FIG. 3, recognize complementary expressions to avoid evaluating duplicate expressions, and focus instead on evaluating unique XPATH expressions. A “complementary” expression is defined in terms of Boolean logic. For example, if an expression “A” is true, then all cases that refer to the expression “not A” are false.

Authors of HD-DVD content may use state:value on a given “hidden” input element, to control the behavior of timing containers. When the same expression is used multiple times, but in the context of different time containers, only one evaluation of the expression may be sufficient. The other references to the expression may be updated to reflect the state of the one evaluation.

Similarly, expressions that are complementary (i.e., that use the opposite Boolean operator) than these expressions may also be skipped, because only one evaluation is sufficient to determine if any subsequent complementary expressions are true or false. Consider the following cues:

<cue begin=”id(‘myButton1’)[state:value( ) = ‘HELLO’]” . . .>
<cue begin=”id(‘myButton1’)[style:value( ) != ‘HELLO’]” . . . >
<cue begin=”id(‘myButton1’)[style:value( ) = ‘WORLD’]” . . . >

Assume that a timing engine evaluates the first cue, and determines that it is active (or true). In this case, the timing engine may skip evaluating the second cue, because the second cue would be the opposite result of the first cue evaluation. Also, the timing engine may skip evaluating the third cue, because if the first cue is true, then the third cue cannot also be true.

This optimization may be implemented using referential data structures that can be modified during load time to link related and complimentary expressions. These referential data structures may also be accessible during on tick processing so they may update the resolution of the expression as an evaluation is being done.

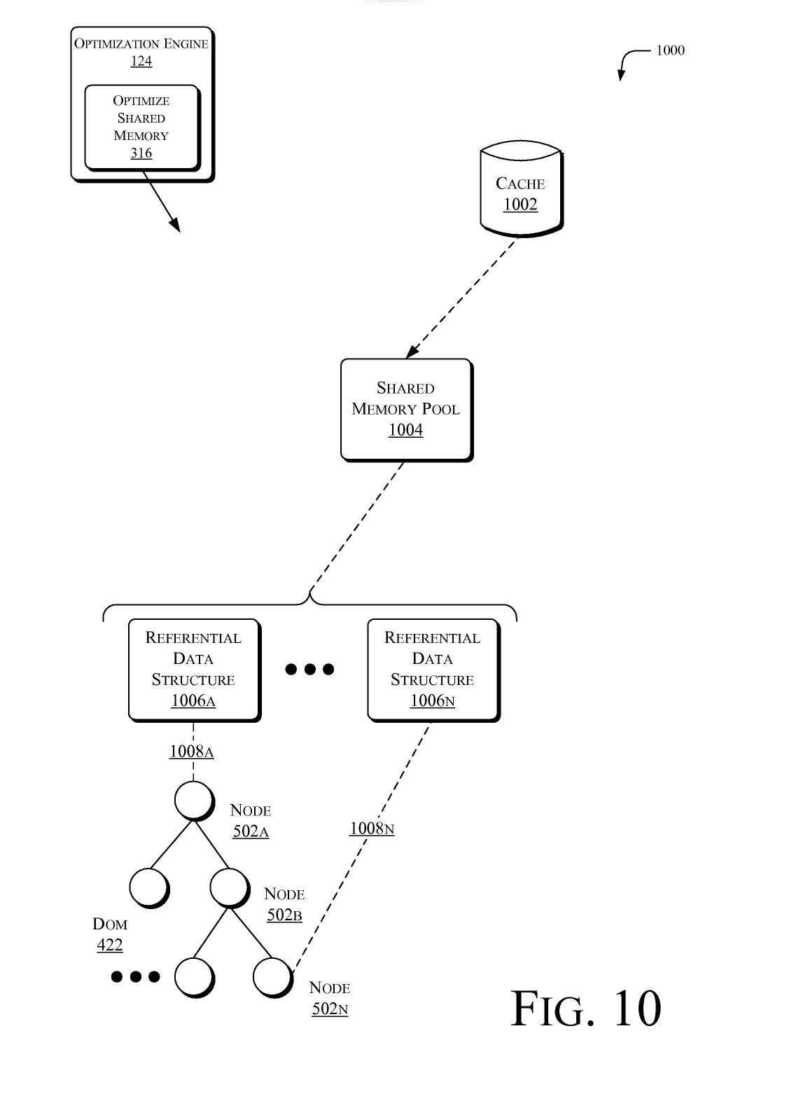

FIG. 10 illustrates components and flows 1000 related to optimizing the processing of timing markup using a shared memory pool. For convenience but not limitation, some elements described previously are carried forward into FIG. 10, and denoted by identical reference numbers.

FIG. 10 provides more detail regarding optimization techniques involving the use of shared memory, represented generally at block 316 in FIG. 3. An optimization engine (e.g., 124) may implement these optimization techniques 316.

A cache 1002 may be implemented as a shared memory pool 1004. The shared memory pool may store a plurality of small fixed sized referential data structures (e.g., at 1006a and 1006n) that encapsulate the information for efficiently traversing the DOM timing tree (e.g., at 422, with timing nodes 502).

The data structures allow for multiple sort links, and allows for skipping over groups of timing nodes based on the states of the nodes. FIG. 10 shows examples of such links at 1008a (linking the structure 1006a to node 502a) and at 1008n (linking the structure 1008n to node 502n).

The shared memory pool 1004 facilitates quick traversal of the DOM tree because the memory is easily locally cached for CPUs that support a L1 data cache. The referential nature of the data structures 1006 supports the ability to skip over multiple nodes in the markup timing based on their state. Additionally, the data structures provide the ability to quickly traverse the entire DOM tree using an index-increment or a pointer-add operation. In conjunction with these techniques, related shared memory pools can be used to aid in the relationship of XPATH expressions, sort indices, and lookup keys that facilitate fast and space-efficient lookups of timing and XPATH-related data structures.

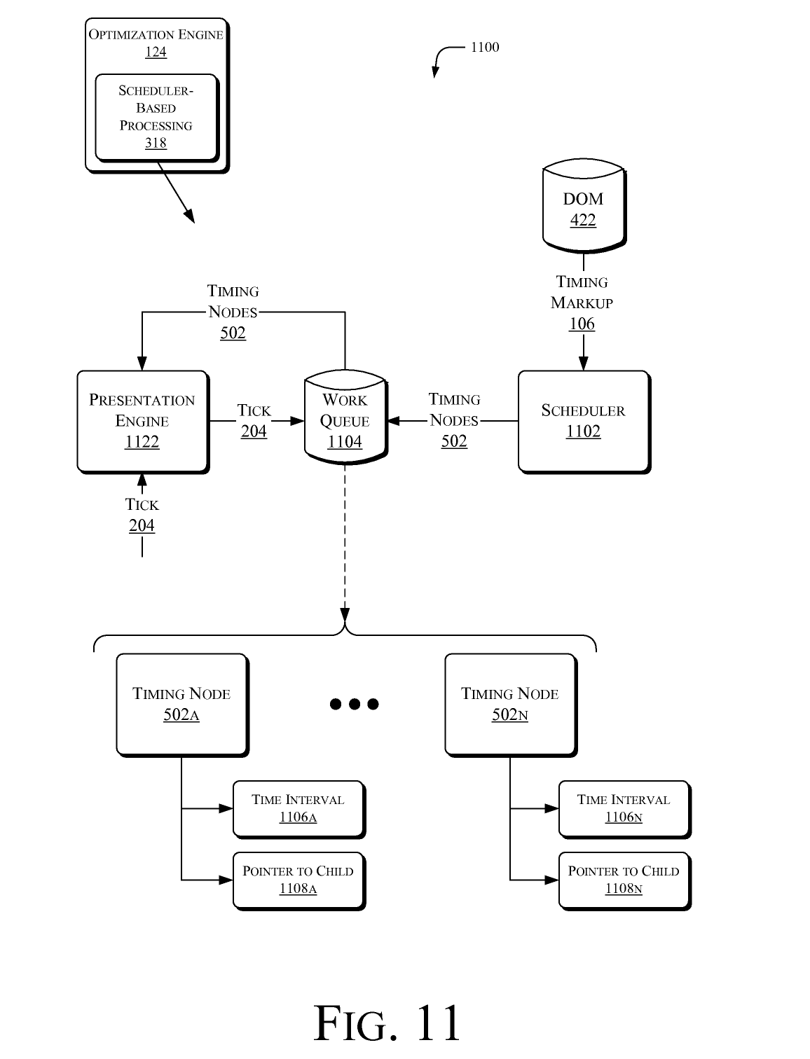

Having described the optimization techniques related to use of shared memory pools in FIG. 10, the discussion proceeds to a description of optimization techniques related to using schedulers, now presented with FIG. 11.

FIG. 11 illustrates optimization techniques related to using schedulers 1102 to avoid performing complete timing tree traversals. The scheduler 1102 places timing nodes 502 from the timing markup 106 into a work queue 1104. More specifically, the scheduler 1102 places only those timing nodes that may pertinent for evaluation at any given tick. Each item or timing node in the work queue work processed by the scheduler may contain a reference to a timing interval (e.g., 1106a and 1106n) and its associated children (e.g., 1108a and 1108n).

The work queue may be ordered by begin time and then lexically later as it appears in the markup DOM. This ordering increases the probability that only timing intervals that are to be evaluated or processed would be placed in the work queue, thus eliminating any superfluous timing tree processing. Additionally, this mechanism may also allow better serialization of operations that may potentially happen out of band (e.g., gesture processing). This approach can be used in conjunction with the memory pool approach above to allow better cache locality of the work items and associated data.

Conclusion

While the foregoing description is presented in the context of optimized processing of HD-DVD timing markup, it is noted that the tools and techniques described herein may be suitable for processing other types of media, or for processing markup of types other than those described herein.

Although the systems and methods have been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

In addition, regarding certain data and process flow diagrams described and illustrated herein, it is noted that the processes and sub-processes depicted therein may be performed in orders other than those illustrated without departing from the spirit and scope of the description herein. Also, while these data and process flows are described in connection with certain components herein, it is noted that these data and process flows could be performed with other components without departing from the spirit and scope of the description herein.

1. One or more machine-readable storage media comprising machine-readable instructions that, when executed by the machine, cause the machine to perform a method comprising:
receiving timing markup read from a high-definition digital versatile disk (HD-DVD); and
optimizing processing of the timing markup.

2. The machine-readable storage media of claim 1, wherein the instructions for optimizing processing of the timing markup include instructions for optimizing the processing of the timing markup by pre-computing at least one XPATH expression included in the timing markup.

3. The machine-readable storage media of claim 2, wherein the instructions for optimizing processing of the timing markup include instructions for identifying at least one intermediate expression within the XPATH expression.

4. The machine-readable storage media of claim 2, wherein the instructions for optimizing processing of the timing markup include instructions for caching at least one intermediate expression identified within the XPATH expression.

5. The machine-readable storage media of claim 2, wherein the instructions for optimizing processing of the timing markup include instructions for evaluating at least one intermediate expression identified within the XPATH expression.

6. The machine-readable storage media of claim 2, wherein the instructions for optimizing processing of the timing markup include instructions for identifying a plurality of intermediate expressions within the XPATH expression, and instructions for associating the intermediate expressions with respective nodes in a document object model.

7. The machine-readable storage media of claim 1, wherein the instructions for optimizing processing of the timing markup include instructions for optimizing the processing of the timing markup by identifying expressions in the timing markup, and instructions for determining whether values of the expressions are dependent on the occurrence of predefined events.

8. The machine-readable storage media of claim 7, further comprising instructions for associating the predefined events with event identifiers, wherein the events are associated with user input.

9. The machine-readable storage media of claim 8, further comprising instructions for associating the event identifiers with at least one of the expressions, wherein the at least one expression is dependent on occurrence of at least one of the predefined events.

10. The machine-readable storage media of claim 1, further comprising instructions for receiving an indication that a timing tick has occurred.

11. The machine-readable storage media of claim 10, further comprising receiving at least one XPATH expression in response to receiving the indication of the tick.

12. The machine-readable storage media of claim 11, further comprising instructions for receiving an indication that user input has occurred, and for associating the user input with at least one predefined event.

13. The machine-readable storage media of claim 12, further comprising instructions for determining whether the XPATH expression is dependent on occurrence of the predefined event.

14. The machine-readable storage media of claim 13, further comprising instructions for re-evaluating the XPATH expression if it is dependent on occurrence of the predefined event.

15. The machine-readable storage media of claim 13, further comprising instructions for retrieving a previous value of the XPATH expression if it is independent of occurrence of the predefined event.

16. The machine-readable storage media of claim 1, wherein the instructions for optimizing processing of the timing markup include instructions for optimize the processing using a finite state machine.

17. The machine-readable storage media of claim 1, wherein the instructions for optimizing processing of the timing markup include instructions for optimizing the processing by identifying a plurality of expressions occurring in the timing markup, and for recognizing that a least two of the expressions are complementary to one another.

18. The machine-readable storage media of claim 1, wherein the instructions for optimizing processing of the timing markup include instructions for optimizing the processing by using a shared memory pool.

19. The machine-readable storage media of claim 1, wherein the instructions for optimizing processing of the timing markup include instructions for optimizing the processing by using a scheduler.

20. An HD-DVD player device including the machine-readable storage media of claim 1.
